(19) United States
(12) Patent Application Publication
(10) Pub. No.: US 2016/0365991 A1
(43) Pub. Date: Dec. 15, 2016

(54) Method and System for Performing Optimized Channel Estimation

(71) Applicant: SIGNALCHIP INNOVATIONS PRIVATE LIMITED, Bangalore (IN)

(72) Inventors: Aravind Ganesan, Bangalore (IN); Deepak Karkala, Bangalore (IN); Rajesh Mundhada, Bangalore (IN)

(21) Appl. No.: 14/876,586

(22) Filed: Oct. 6, 2015

(30) Foreign Application Priority Data
Jun. 11, 2015 (IN) 2935/CHE/2015

(51) Int. Cl. H04L 25/02; H04B 1/7115; H04B 1/7093; H04B 7/26

(52) U.S. Cl. CPC H04L 25/0204; H04B 7/2628; H04L 25/0212; H04B 1/7115; H04B 1/7093; H04B 2201/70979

(57) ABSTRACT

A system and method for performing channel estimation includes a sampling device for sampling a chip based radio signal to generate a plurality of samples. Further, the system includes a coarse path searcher for performing correlation operations of a local pattern with a time shifted first set of samples to obtain correlation values in an uncertainty region. Further, the system includes a Region of Interest (ROI) module determine one or more regions of interest in the uncertainty region. Moreover, the system includes a fine path searcher for performing correlation operations of the local pattern with a time shifted second set of samples to obtain correlation values in the one or more regions of interest.

### PRIORITY APPLICATION

This application claims priority from an Indian Non-Provisional Patent Application No. 2935/CHE/2015 filed on Jun. 11, 2015, which is incorporated in its entirety herewith.

### FIELD OF THE INVENTION

The present invention relates to a field of channel estimation in WCDMA systems, and more specifically to performing channel estimation in a WCDMA device.

### BACKGROUND

In a Wideband Code Division Multiple Access (WCDMA) system, WCDMA signals are transmitted in frames via communication channels. WCDMA signals contain data and pilot signals. The pilot signals contain pilot channels of one of uplink signals and downlink signals. A communication channel modifies a WCDMA signal propagating through the communication channel. The WCDMA signal takes time to propagate through the communication channel and hence, time taken by the WCDMA signal to propagate through the communication channel introduces a channel delay for the WCDMA signal. The channel delay depends on distance between a base station and a user device. Hence an accurate value of the channel delay is unpredictable. As a result, beginning of a pilot signal in the frame is unpredictable. An uncertainty time interval is the sum of round-trip delay of farthest user device operating from the base station and expected maximum channel spread. Hence, the beginning of the pilot signal is well within a segment of the frame having a time interval equal to uncertainty time interval. The segment of the frame having the beginning of the pilot signal is hereinafter referred to as uncertainty region.

Further, the WCDMA signal undergoes multiple reflections in the communication channel. As a result, the WCDMA signal splits into multi-path components, each component following a different path to traverse through the communication channel. Each multi-path component encounters channel delay. The channel delay is measured as an integer chip delay and phase which represents a fractional chip delay. Further, each multi-path component differs from the WCDMA signal by a phase difference. A receiver keeps receiving the multi-path components of the WCDMA signal for a fixed time-interval before and after reception of the pilot signal. The fixed time interval is a channel spread window. To ensure high fidelity, the multipath components throughout the fixed time interval have to be received and coalesced in accordance to the respective phase differences. Hence, the channel spread window is a region of interest in the uncertainty region. The channel delay in the communication channel determines location of the region of interest in the uncertainty region.

For efficient communication, a base station has to anticipate location of the region of interest in the uncertainty region. Moreover, for proper functioning, the base station requires multipath components to be coalesced in order to ensure fidelity in reception. A RAKE receiver in the base station coalesce the multipath components of the WCDMA signal into a single signal. However, the RAKE receiver requires accurate phase and delay information regarding each multipath component, which is estimated from the pilot signal. Further, the RAKE receiver requires channel state information. The channel state information includes channel estimate, delay information and phase information. The channel estimate is a complex number representing gain and phase shift caused on the WCDMA signal by the channel. Process of estimating the channel state information and multipath components is referred to as channel estimation. Existing systems use a plurality of methods to perform channel estimation and to identify multipath components in a received WCDMA signal. However, the existing systems are plagued with several disadvantages.

In one existing system, the base station receives radio signals via a receiver antenna. The received radio signal is a mixture of atmospheric noise, the uplink signal, and multipath components of the uplink signal. For efficient communication, the base station has to anticipate and identify the arrival of uplink signal in the frame. The beginning of the uplink signal is present in the uncertainty region of the frame. Throughout the uncertainty region, a channel estimator in the base station performs correlations between a local pattern and samples of the received radio signal. The local pattern is product of a training sequence and a scrambling code of the user device. The training sequence contains pilot bits. The pilot bits are control bits known to be present in the uplink signal. As a result, correlation values peak when a sample of the received radio signal with pilot bits is correlated with the local pattern. Hence peaks in the correlation values signify the arrival of the uplink signal into the receiver antenna. Further, to calculate accurate phase information of the uplink signal, the local pattern has to be correlated with samples several times smaller than chips in the uplink signal. The local pattern has to be correlated with samples with a finer resolution. Hence, engineers set the sampling rate to be several times chip rate of the uplink signal. The existing system has several disadvantages. In the system, a sampling device samples the received radio signal at a sampling rate equal to an integral multiple of the chip rate. Because of a high sampling rate, the sampling process generates a large number of samples. Further, the channel estimator performs correlations of all the samples of the received radio signal throughout the uncertainty region. The base station performs a large number of correlation operations. Hence, the base station requires high processing capability and hardware complexity. Further, the hardware complexity of the base station render implementation of the system in femto cell base stations difficult and expensive. Moreover, the number of samples generated increases with increase in cell size because with increase in cell size the round trip delay of the farthest user device operating from the base station increases.

FIG. 1 is a block diagram of a channel estimator 100 in a base station in accordance with a prior art. The channel estimator 100 calculates path delay information, phase information, multipath locations and channel estimate of an uplink signal received from a user device. Examples of the user device include, but are not limited to mobile phones, tablet computers, laptops, and wireless internet dongles. Further, in one embodiment of the present invention, the user device is another WCDMA base station. The base station receives the uplink signal as part of a radio signal received at a receiver antenna. The received radio signal is a mixture of atmospheric noise, the uplink signal, and multipath components of the uplink signal. The multipath components of the uplink signal are delayed versions of the uplink signal created as a result of multipath propagation. The uplink signal is a chip based signal.

The channel estimator 100 includes a sampling device 105, a correlation calculator 110, filters 115, a local pattern generator 120, a threshold computation module 125, and an output module 150. The sampling device 105 samples the received radio signal at a sampling rate equal to product of an over sampling index and chip rate of the uplink signal. The sampling device 105 transmits the radio signal samples to the correlation calculator 110. The correlation calculator 110 is a digital signal processor capable of calculating correlation values of the radio signal samples with a local pattern. The local pattern is product of a training sequence and a scrambling code of the user device. The training sequence contains pilot bits. The pilot bits are control bits known to be present in the radio signal. As a result, correlation values reach a peak value when a radio signal sample with pilot bits is correlated with the local pattern. Hence peaks in the correlation values signify the arrival of the radio signal in the receiver antenna.

The local pattern is an output of the local pattern generator 120. The local pattern generator 120 generates the local pattern by multiplying the scrambling code with the training sequence. Further, the local pattern generator 120 samples product of the training sequence and the scrambling code at the sampling rate equal to product of the over sampling index m and the chip rate of the uplink signal.

The correlation calculator 110 calculates correlation values of the local pattern with samples of the received radio signal. The correlation calculator 110 further transmits calculated correlation values to the filter 115. Examples of filters 115 include but are not limited to moving-average filters, block average filters, and Kalman filter. The filters 115 scales correlation values obtained from the correlation calculator 110. Further, the filters 115 removes effect of noise from the calculated correlation values and transmit the scaled correlation values to the threshold computation module 125 and the output module 150.

The threshold computation module 125 includes a mean calculator 130 and a threshold computation module 135. The mean calculator 130 finds average of correlation values calculated by the correlation calculator 110. Further, the threshold computation 135 determines a threshold correlation value based on the average of the correlation values. The correlation values greater than the average of correlation values are correlation peak values.

The output module 150 includes a peak searcher 140 and a peak remover 145. The peak searcher 140 searches for correlation peak values. Further, the peak remover 145 removes correlation peak values lower than the threshold correlation value.

The output module 150 calculates the chip delay, the path power estimates, and the channel estimate from the correlation peak values. Further, the output module 150 calculates phase information of the uplink signal from the correlation peak values. Furthermore, the output module 150 identifies multipath components in the uplink signals. Further, the output module 150 outputs path delay 155, the phase information, channel estimate 160, path power estimate 165, and details about the multipath components to a RAKE receiver. The RAKE receiver coalesce the multipath components to form the uplink signal.

The channel estimator 100 has several disadvantages. The channel estimator 100 performs correlation for all samples of the received radio signal. Number of samples is large because of a high sampling rate. Moreover, the channel estimator 100 has to perform correlations for all user devices operating under the base station. Hence, the channel estimator 100 requires large processing power for efficient performance.

Further, the base station performs channel estimation for each user device operating with the base station. As a result, the hardware complexity of the base station increases linearly with increase in the number of user devices operating under the base station. Hence, in existing systems, the base station has constraints in the cell size and number of users supported by the base station. The constraints in cell size and number of users are eradicated by optimizing number of correlation operations required for channel estimation.

In light of the foregoing discussion, there is a need for a system to perform channel estimation with an optimum number of correlation operations. Further, there is a need for a system with base stations capable of supporting an increased number of users and increased cell size. Furthermore, there is a need for a system capable of being implemented in a femto cell base station.

### SUMMARY

The above mentioned needs are met by a method and system for channel estimation with an optimum number of correlation operations.

An example of a system for performing channel estimation includes a sampling device for sampling a chip based radio signal to generate a plurality of samples. Further, the system includes a coarse path searcher for performing correlation operations of a local pattern with a time shifted first set of samples to obtain correlation values in an uncertainty region. Further, the system includes a Region of Interest (ROI) module determine one or more regions of interest in the uncertainty region. Moreover, the system includes a fine path searcher for performing correlation operations of the local pattern with a time shifted second set of samples to obtain correlation values in the one or more regions of interest.

An example of a method of performing channel estimation includes sampling a chip based radio signal to generate a plurality of samples. The method includes performing correlation operations of a local pattern with a time shifted first set of samples to obtain correlation values in an uncertainty region. Further, the method includes determining one or more regions of interest. Furthermore, the method includes performing time shifting of the sampled radio signal based on the channel delay to generate a time shifted radio signal. Moreover, the method includes performing correlation operations of the local pattern with a time shifted second set of samples to obtain correlation values in the one or more regions of interest. Moreover, the method includes estimating channel state information based on the correlation operations of the local pattern with the second set of samples of the time shifted radio signal.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF FIGURES

In the following drawings like reference numbers are used to refer to like elements. Although the following figures depict various examples of the invention, the invention is not limited to the examples depicted in the figures.

FIG. 1 is a block diagram of a channel estimator in accordance with a prior art;

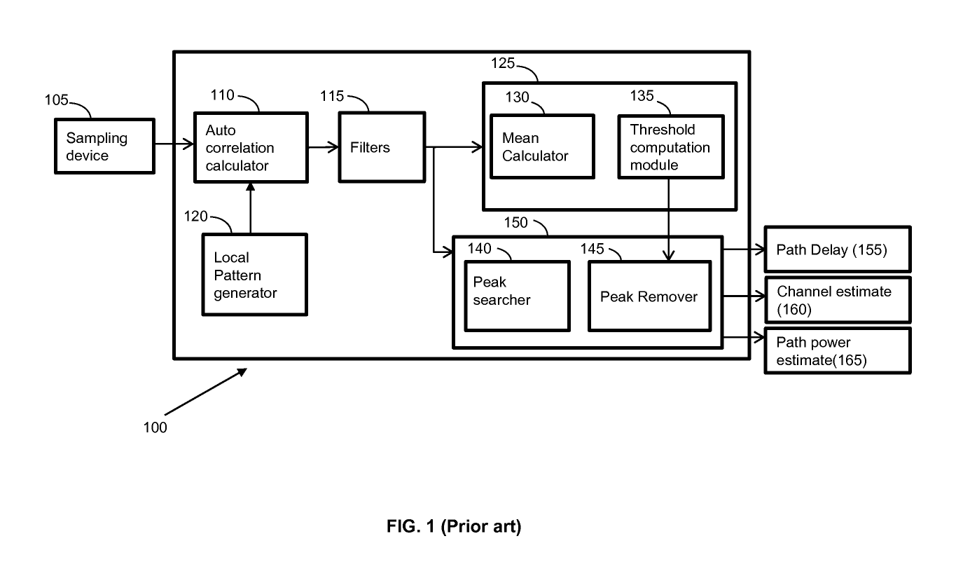

FIG. 2 is a block diagram of a channel estimator in accordance with one embodiment of the present invention;

FIG. 3 is a flowchart illustrating a method of performing channel estimation in a WCDMA system, in accordance with one embodiment of the present invention;

FIG. 4 is a flow diagram illustrating functioning of a coarse path searcher, in accordance with one embodiment of the present invention;

FIG. 5 is a flow diagram illustrating functioning of a fine path searcher, in accordance with another embodiment of the present invention; and

FIG. 6 is a block diagram of a coarse path searcher, in accordance with one embodiment of the present invention.

### DESCRIPTION

In the present disclosure, relational terms such as first and second, and the like, may be used to distinguish one entity from the other, without necessarily implying any actual relationship or order between such entities. The following detailed description is intended to provide example implementations to one of ordinary skill in the art, and is not intended to limit the invention to the explicit disclosure, as one or ordinary skill in the art will understand that variations can be substituted that are within the scope of the invention as described.

Embodiments of the present disclosure described herein disclose an enhanced channel estimator capable of performing channel estimation with an optimum number of correlation operations. Further, the present disclosure discloses a channel estimator capable of reducing hardware complexity and processing capability required for channel estimation. Furthermore, the present disclosure discloses a channel estimator capable of being implemented in a femtocell base station.

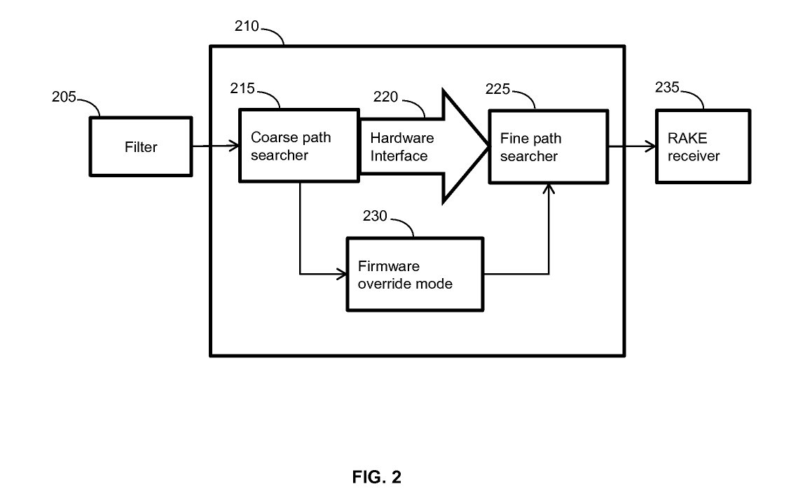

FIG. 2 is a block diagram of a channel estimator 210 in accordance with one embodiment of the present invention. The channel estimator 210 is a dual stage channel estimator. The channel estimator 210 performs channel estimation on a radio signal to calculate channel state information. The radio signal is a mixture of atmospheric noise, a Wideband Code division Multiple Access (WCDMA) signal from a WCDMA device, and multipath components of the WCDMA signal. The WCDMA signal consists of a pilot signal and a data signal. The pilot signal contains pilot channels of uplink signals and downlink signals. The data signal contains one or more data channels. Further, the radio signal is a chip based radio signal. Examples of the WCDMA devices include but are not limited to WCDMA base stations, and WCDMA user devices. Examples of the WCDMA user device include mobile phones, tablet computers, personal computers. The user device transmits the WCDMA signals as frames via communication channels.

A communication channel introduces a channel delay to the radio signal propagating through the communication channel. The channel delay depends on distance between a WCDMA base station and a WCDMA user device. Hence an accurate value of the channel delay is unpredictable. As a result, beginning of a WCDMA signal and the pilot signal in the frame is unpredictable. The uncertainty time interval is the sum of round-trip delay of farthest WCDMA user device operating from the WCDMA base station and expected maximum channel spread. Hence, the beginning of the pilot signal is well within a segment of the frame having a time interval equal to uncertainty time interval. The segment of the frame having the beginning of the pilot signal is hereinafter referred to as uncertainty region. Further, the radio signal undergoes multiple reflections in the communication channel. As a result, the radio signal splits into multi-path components, each component following a different path to traverse through the communication channel. Each multi-path component encounters channel delay and each multi-path component differs from the radio signal by a phase difference. A receiver keeps receiving the multi-path components of the WCDMA signal for a fixed time-interval before and after reception of the radio signal. Further, a RAKE receiver coalesces the multi-path components into a strong signal. The fixed time interval is referred to as the channel spread window. To ensure high fidelity, the multipath components throughout the fixed time interval have to be received and coalesced in accordance to the respective phase differences. Hence, the channel spread window is a region of interest in the uncertainty region. Regions of interest are portions of the uncertainty region with signal energy greater than a threshold signal energy. The regions of interest are regions where channel impulse response of the communication channel is expected to occur. The uncertainty region has at least one region of interest. The channel delay in the communication channel determines location of the one or more regions of interest in the uncertainty region. In one embodiment of the present invention, the uncertainty region has one region of interest, with the region of interest being a continuous portion of the uncertainty region. In another embodiment of the present invention, the uncertainty region has multiple temporally and spatially discontinuous regions of interest. The channel delay, location of the channel spread window, and beginning of the pilot signals are results of a channel estimation operation by the channel estimator 210.

The channel estimator 210 includes a coarse path searcher 215, a hardware interface 220, a fine path searcher 225, and a firmware override mode 230. The coarse path searcher 215 and the fine path searcher 225 perform channel estimation using the pilot signal. The channel estimator 210 is implemented in a Wideband Code Division Multiple Access (WCDMA) device. Further, the channel estimator 210 is connected to a filter 205 and a RAKE receiver 235. An antenna receives the radio signal. The filter 205 receives samples of the received radio signal from a sampling device. The sampling device samples the received radio signal at a sampling rate equal to product of an oversampling index and the chip rate of the WCDMA signal. The over sampling index is configurable. The sampling device generates a plurality of samples of the received radio signal. The sampling device samples each chip in the received radio signal at a plurality of phases. The filter 205 filters out noise component in the received radio signal. The filter 205 transmits the output to the channel estimator 210. Examples of the filter 205 include but are not limited to moving-average filters, block average filters, and Kalman filters.

The coarse path searcher 215 receives samples of the received radio signals occurring within the uncertainty region. The coarse path searcher 215 selects a first set of samples from the received samples. Samples in the first set of samples share a common phase among the plurality of phases. The coarse path searcher 215 performs a first set of correlation operations between a local pattern and a time shifted first set of samples to obtain correlation values within the uncertainty region. The local pattern is product of a training sequence and a scrambling code of the user device. The training sequence contains pilot bits. The pilot bits are control bits known to be present in the pilot signal. As a result, correlation values shoots up when a sample of the received radio signal with pilot bits is correlated with the local pattern. The WCDMA device uses the pilot bits to identify the one or more regions of interest in the uncertainty region. Beginning of a first region of interest among the one or more regions of interest in the uncertainty region denotes the beginning of the pilot signal in the frame. Further, the coarse path searcher 215 performs the first set of correlation operations to calculate channel delay in the WCDMA signal. The coarse path searcher 215 performs time shifting of the frame in accordance with the channel delay. The frame contains the multi-path components of the WCDMA signals. The coarse path searcher 215 calculates the channel delay by performing the first set of correlation operations at a first rate equal to the chip rate of the WCDMA signal.

The coarse path searcher 215 computes absolute values of results of the first set of correlation operations. Results of the first set of correlation operations are hereafter referred to as first set of correlation values. In one embodiment of the present invention, the coarse path searcher 215 computes absolute squared values of results of the first set of correlation operations. In another embodiment of the present invention, the coarse path searcher 215 computes sum of in-phase and quadrature parts of the first set of correlation values. Further, the coarse path searcher 215 calculates noise mean of the received radio signal from the first set of correlation values. The noise mean of the received radio signal is average of the first set of correlation values. The coarse path searcher 215 transmits the noise mean to the fine path searcher 225.

Further, the coarse path searcher 215 sets a first threshold correlation value in order to identify correlation peak values. The first threshold correlation value is product of a scaling factor K1 and the noise mean. The coarse path searcher 215 identifies correlation values greater than the first threshold correlation value as valid correlation peak values. The coarse path searcher 215 uses the valid correlation peak values to identify the one or more regions of interest in the uncertainty region.

In one embodiment of the present invention, the coarse path searcher 215 informs the firmware override module 230 of locations of the valid correlation peaks values. The firmware override module 230 identifies the one or more regions of interest from the locations of the valid correlation peak values.

In another embodiment of the present invention, the coarse path searcher 215 informs the hardware interface 220 of locations of the valid correlation peak values. In one embodiment of the present invention, the hardware interface 220 is referred to as a Region of Interest module. The Region of interest module identifies the one or more regions of interest from the locations of the correlation peak values. Further, the hardware interface 220 calculates the channel delay. The hardware interface 220 functions in one of two modes of operations. In a first mode of operation, the hardware interface 220 selects a correlation peak. The hardware interface 220 assigns the selected correlation peak value as a valid correlation peak value if the selected correlation peak is greater than three adjacent correlation peaks. The hardware interface 220 marks portion of the uncertainty region around the valid correlation peak value as a region of interest. In a second mode of operation, the hardware interface 220 selects strongest correlation peak and identifies portion of the uncertainty region around the valid correlation peak value as a region of interest. The hardware interface 220 transmits the information regarding the locations of valid correlation peak values and the one or more regions of interest to the fine path searcher 225.

The firmware override mode 230 transmits location of valid correlation peak values and the one or more regions of interest to the fine path searcher 225. Further, the firmware override mode 230 instructs the fine path searcher 230 to perform correlations of a time shifted second set of samples and the local pattern to obtain correlation values in the one or more regions of interest. Further, the second set of samples contains samples of the received radio signal present in the one or more regions of interests in the uncertainty region. The second set of samples includes samples of the received radio signal having the plurality of phases. Further, the second set of samples has been shifted in accordance with the channel delay.

The fine path searcher 225 performs a second set of correlation operations between the time shifted second set of samples and the local pattern to obtain correlation values in the one or more regions of interest. The fine path searcher 225 performs the second set of correlation operations at a second rate equal to product of the chip rate and the over sampling index. The second set of correlation operations result in a second set of correlation values. The fine path searcher 225 calculates the absolute values of the second set of correlation values. Further, the fine path searcher 225 filters complex correlation values in the second set of correlation values to generate averaged correlation values. The fine path searcher 225 derives channel estimate from the averaged correlation value at the peak position. The fine path searcher 225 identifies the multi-path components in the one or more regions of interest in accordance with the second set of correlation values.

Moreover, the fine path searcher 225 calculates accurate phase information of the WCDMA signal from the second set of correlation values. Further, the fine path searcher 225 identifies correlation values of multipath components in the received radio signal. Multipath components are delayed versions of the WCDMA signals resulting from multipath propagation. Positions of the multipath components in the frame of the pilot signal are referred to as multipath locations. To identify multipath components and multipath locations, the fine path searcher 225 receives the noise mean from the coarse path searcher 215. In one embodiment of the present invention, the fine path searcher 225 sets a second threshold correlation value. The second threshold correlation value is product of a second scaling factor K2 and the noise mean. The fine path searcher 225 identifies positions of correlation values greater than the second threshold correlation value to be valid multipath locations. The fine path searcher 225 transmits accurate phase information of the pilot signal, the multipath locations, power of multipath components, and chip delay of the pilot signal to the RAKE receiver 235. The RAKE receiver 235 uses phase information, the chip delay, and the channel estimate to compensate for multipath fading.

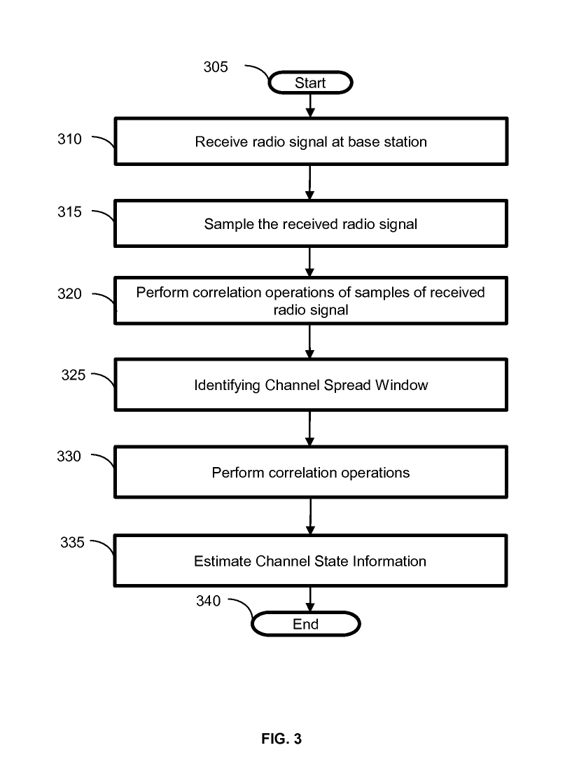

FIG. 3 is a flowchart illustrating method of performing enhanced channel estimation in a Wideband Code Division Multiple Access system (WCDMA) system, in accordance with one embodiment of the present invention. A process illustrated by the flowchart begins at step 305.

At step 310, a receiver antenna at a WCDMA device receives a radio signal. The received radio signal is a mixture of atmospheric noise, a Wideband Code Division Multiple Access (WCDMA) signal transmitted by a WCDMA device, and multipath components of the WCDMA signal. The WCDMA signal includes pilot signals and data signals. The pilot signal contains pilot channels uplink signals and a downlink signals. Examples of the WCDMA device include WCDMA base stations and WCDMA user devices. Examples of WCDMA user devices include but are not limited to mobile phones, tablet computers, and internet dongles. The WCDMA device transmits the WCDMA signal as frames via communication channels. The WCDMA signal is a chip based radio signal.

A communication channel modifies a radio signal propagating through the communication channel in several ways. In the case of a WCDMA signal, the channel delay depends on distance between a WCDMA base station and a WCDMA user device. Hence an accurate value of the channel delay is unpredictable. As a result, beginning of a pilot signal in the frame is unpredictable. The uncertainty time interval is the sum of round-trip delay of farthest WCDMA user device operating from the WCDMA base station and expected maximum channel spread. Hence, the beginning of the pilot signal is well within a segment of the frame having a time interval equal to uncertainty time interval. The segment of the frame having the beginning of the pilot signal is hereinafter referred to as uncertainty region. Further, the WCDMA signal undergoes multiple reflections in the communication channel. As a result, the WCDMA signal splits into multi-path components, each multi-path component following a different path to traverse through the communication channel. Each multi-path component differs from the WCDMA signal by a phase difference.

A receiver keeps receiving the multi-path components of the WCDMA signal for a fixed time-interval. Further, a RAKE receiver coalesce the multi-path components into a strong signal. The fixed time interval is referred to as the channel spread window. To ensure high fidelity, the multipath components throughout the fixed time interval have to be received and coalesced in accordance to the respective phase differences. Hence, the channel spread window is a region of interest in the uncertainty region. Region of interest are portions of the uncertainty region with maximum signal energy. The uncertainty region has at least one region of interest. Regions of interest are portions of the uncertainty region with signal energy greater than a threshold signal energy. The regions of interest are regions where channel impulse response of the communication channel is expected to occur. The channel delay in the communication channel determines location of the first regions of interest among the one or more regions of interest in the uncertainty region. In one embodiment of the present invention, the uncertainty region has one region of interest, with the region of interest being a continuous portion of the uncertainty region. In another embodiment of the present invention, the uncertainty region has multiple temporally and spatially discontinuous regions of interest. Beginning of the region of interest determines beginning of the pilot signal in the frame. The channel delay, location of the channel spread window, and beginning of the pilot signals are results of a channel estimation operation by the channel estimator.

At step 315, a sampling device samples the received radio signal at a sampling rate equal to product of an oversampling index and the chip rate of the WCDMA signal. The sampling device generates a plurality of samples of the received radio signal. The received radio signal is a chip based radio signal and the sampling device samples the received radio signal at the sampling rate equal to a multiple of the chip rate. Hence, sampling device samples each chip in the radio signals into samples belonging to a plurality of phases. Total number of phases in the plurality of phases equals the oversampling index.

At step 320, a coarse path searcher performs a first set of correlation operations between a time shifted first set of samples of the WCDMA signal and a local pattern to obtain correlation values in the uncertainty region. The received radio signal contains the pilot signal. The first set of samples includes samples sharing a common phase among the plurality of phases. The local pattern is product of a training sequence and a scrambling code of the user device. The training sequence contains pilot bits. The pilot bits are control bits known to be present in the pilot signal. As a result, correlation values peak when a sample of the pilot signal is correlated with the local pattern. Hence peaks in the correlation values signify location of beginning of the pilot signal in the received radio signal. Hence the WCDMA device uses the pilot bits to identify arrival of the pilot signal. Further, the WCDMA device uses the pilot bits to identify the beginning of the one or more regions of interest.

At step 325, the coarse path searcher identifies one or more regions of interest from results of the first set of correlation operations. To identify the one or more regions of interest, the coarse path searcher computes absolute values of results of the first set of correlation operations. Results of the first set of correlation operations are hereafter referred to as first set of correlation values. Further, the coarse path searcher calculates noise mean of the received radio signal from the first set of correlation values. The noise mean of the received radio signal is average of the first set of correlation values. Furthermore, the coarse path searcher sets a first threshold correlation value in order to identify correlation peak values. The first threshold correlation value is product of a scaling factor K1 and the noise mean. The coarse path searcher identifies correlation values greater than the first threshold correlation value as correlation peak values. The coarse path searcher uses the correlation peak values to identify the one or more regions of interests. The one or more regions of interest contain the WCDMA signal and the multi-path components of the WCDMA signal. Furthermore, the coarse path searcher identifies channel delay from the first set of correlation values.

At step 330, a fine path searcher performs a second set of correlation operations on a time shifted second samples to obtain correlation values within the one or more regions of interest. The fine path searcher performs correlations for the samples belonging to each phase in the plurality of phases. The second set of correlation operations result in a second set of correlation values. The fine path searcher calculates the absolute values of the second set of correlation values. Further, the fine path searcher filters complex correlation values in the second set of correlation values to generate averaged correlation values. Moreover, the fine path searcher identifies multi-path components of the WCDMA signal. Furthermore, the fine path searcher calculates accurate phase information of each multipath component of the WCDMA signal present in the one or more regions of interest.

At step 335, the fine path searcher estimates channel state information. The channel state information includes channel estimate, chip delay, and phase of the WCDMA signal. The fine path searcher calculates accurate phase information of the WCDMA signal from the second set of correlation values. The fine path searcher transmits the channel state information to a RAKE receiver. The RAKE receiver uses phase information, the chip delay, and the channel estimate to compensate for multipath fading.

The process ends at step 340.

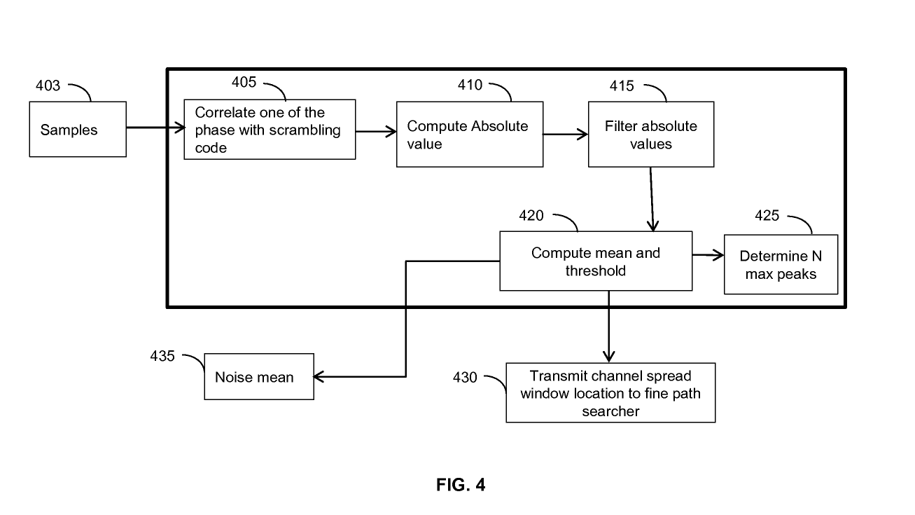

FIG. 4 is a flow diagram illustrating functioning of a coarse path searcher, in accordance with one embodiment of the present invention. The coarse path searcher is part of a dual stage channel estimator. The coarse path searcher receives samples 403 of a received radio signal from a sampling device. The received samples 403 are samples belonging to an uncertainty region in a frame. The received radio signal is a mixture of channel noise, Wideband Code division Multiple Access (WCDMA) signal transmitted by a WCDMA device, multipath components of the WCDMA device, and noise. Examples of the WCDMA device include WCDMA base stations and WCDMA user devices. The WCDMA signal contains data signals and pilot signals. The pilot signals contain pilot channels of uplink signals and downlink signals. The sampling device samples the received radio signal at a sampling rate equal to product of an oversampling index and chip rate of the WCDMA signal. The sampling device generates a plurality of samples 403 of the received radio signal. Samples 403 of the received radio signal belong to a plurality of phases. The number of phases in the plurality of phases is equal to the oversampling index.

At step 405, the coarse path searcher performs a first set of correlation operations between a time shifted samples first set of samples 403 and a local pattern to obtain correlation values within the uncertainty region. The first set of samples 403 belongs to the received set of samples 403. Further, the first set of samples 403 is made of samples having a first phase among the plurality of phases. The local pattern is product of a training sequence and a scrambling code of the user device. The training sequence contains pilot bits. The pilot bits are control bits known to be present in the pilot signal. As a result, correlation values peak when a sample 403 of the received radio signal with pilot bits is correlated with the local pattern. Hence peaks in the correlation values signify the arrival of the pilot signal into the receiver antenna.

At step 410, the coarse path searcher computes absolute values of results of the first set of correlation operations. Results of the first set of correlation operations are hereafter referred to as first set of correlation values.

At step 415, the coarse path searcher filters the absolute values of the first set of correlation values. The coarse path searcher uses digital filters to perform filtering.

At step 420, the coarse path searcher calculates noise mean 435 of the received radio signal from the first set of correlation values. The noise mean 435 of the received radio signal is average of the first set of correlation values. The coarse path searcher transmits the noise mean 435 to a fine path searcher. Further, the coarse path searcher sets a threshold correlation value in order to identify correlation peak values. The threshold correlation value is product of a scaling factor K1 and the noise mean 435.

At step 425, the coarse path searcher identifies correlation values greater than the threshold correlation value as correlation peak values. The coarse path searcher determines N maximum correlation peak values. The coarse path searcher uses the correlation peak values to identify locations of one or more regions of interest in the frame of the WCDMA signal.

At step 430 the coarse path searcher informs the fine path searcher of locations the one or more regions of interest. The coarse path searcher identifies one or more regions of interest from the locations of the correlation peak values.

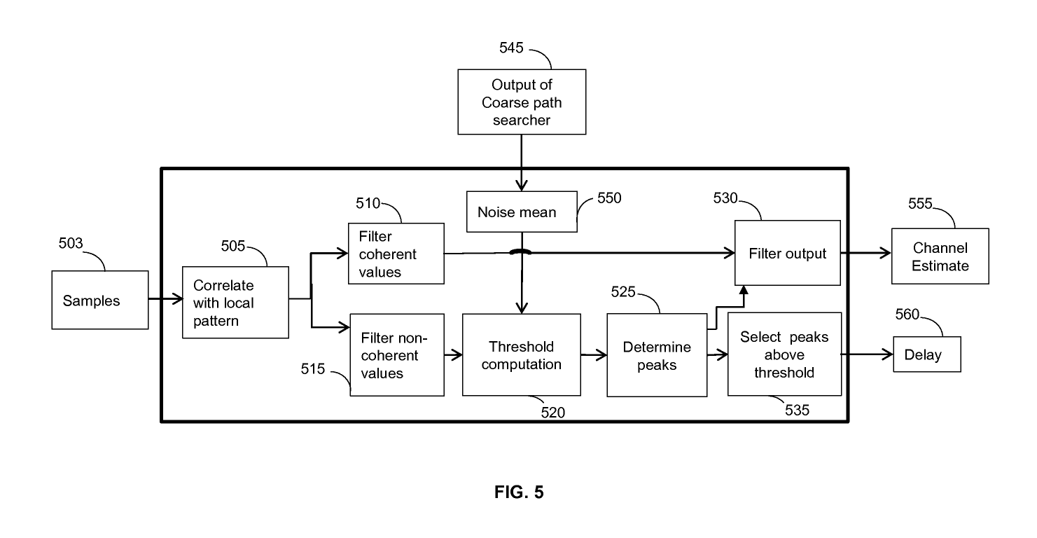

FIG. 5 is a flow diagram illustrating functioning of a fine path searcher, in accordance with one embodiment of the present invention. The fine path searcher is part of a dual stage channel estimator. The fine path searcher receives samples 503 of a received radio signal from a sampling device. The received samples 503 are samples 503 belonging to one or more regions of interest in an uncertainty region of a frame. The received radio signal is a mixture of channel noise, a Wideband Code Division Multiple (WCDMA) signal transmitted by a WCDMA device, multipath components of the WCDMA signal, and noise. The WCDMA contains data signals and pilot signals. The pilot signal contain pilot channels of uplink and downlink signal. Examples of the WCDMA devices include but are not limited to WCDMA base-stations, and WCDMA user devices. The sampling device samples the received radio signal at a sampling rate equal to product of an oversampling index m and chip rate of the WCDMA signal. The sampling device generates a plurality of samples 503 of the received radio signal. Samples 503 of the received radio signal belong to a plurality of phases.

At step 505, the fine path searcher performs a set of correlation operations between a time shifted set of samples 503 of the received radio signal and the local pattern to obtain correlation values in the one or more regions of interest. The set of samples 503 include samples 503 of the received radio signal in the one or more regions of interests. A coarse path searcher identifies locations of the one or more regions of interests in the uncertainty region.

The local pattern is product of a training sequence and a scrambling code of the user device. The training sequence contains pilot bits. The pilot bits are control bits known to be present in the pilot signal. As a result, if a sample 503 of the received radio signal with pilot bits is correlated with the local pattern, correlation values shoots up. Hence peaks in the correlation values signify the arrival of the pilot signal in the frame. The fine path searcher performs correlation operation for samples 503 having a plurality of phases. As a result, the fine path searcher has to perform correlations at a rate equal to the sampling rate of the sampling device. The set of correlation operations result in a set of correlation values. The fine path searcher calculates the absolute values of correlation values among the set of correlation values.

At step 510, the fine path searcher filters complex correlation values in the second set of correlation values to generate averaged correlation values. Filtering of the complex correlation values is referred to as coherent averaging.

At step 515, the fine path searcher filters correlation values in the set of correlation values to locate multipath components. The process of filtering correlation values in the second set of correlation values to locate multipath components is referred to as non-coherent averaging. In one embodiment of the present invention, the fine path searcher filters absolute values of the second set of correlation values. In another embodiment of the present invention, the fine path searcher filters absolute squared values of the second set of correlation values.

At step 520, the fine path searcher sets a threshold correlation value. The threshold correlation value is product of a scaling factor K2 and noise mean 550. The fine path searcher receives the noise mean 550 from the coarse path searcher 545.

At step 525, the fine path searcher identifies correlation peak values in the second set of correlation values. The correlation peak values are correlation values greater than the threshold correlation value.

At step 530, the fine path searcher filters the averaged correlation values generated in step 510. The fine path searcher determines channel estimate 555 from the averaged correlation values at the correlation peak values.

At step 535, the fine path searcher identifies the correlation values greater than the threshold correlation value. Moreover, the fine path searcher calculates accurate phase information of the WCDMA signal from the second set of correlation values. Further, the fine path searcher identifies multipath components in the received radio signal. Multipath components are correlation values generated by delayed versions of the WCDMA signals resulting from multipath propagation. Positions of the multipath components in the WCDMA signal are referred to as multipath locations. The fine path searcher transmits accurate phase information of the WCDMA signal, the multipath locations, power of multipath components, and chip delay of the WCDMA signal to a RAKE receiver. The RAKE receiver uses phase information, the chip delay 560, and the channel estimate 555 to compensate for multipath fading.

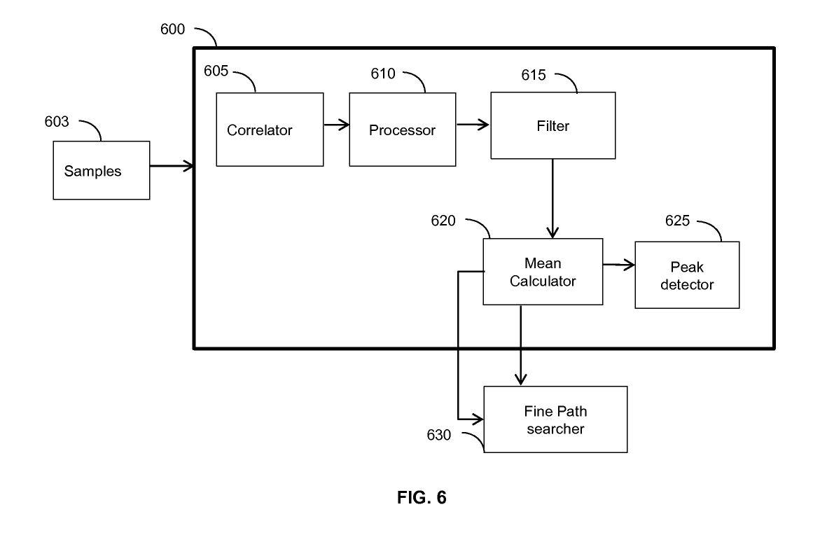

FIG. 6 is a block diagram of a coarse path searcher 600, in accordance with one embodiment of the present invention. The coarse path searcher 600 is part of a dual stage channel estimator. The coarse path searcher includes a correlator 605, a processor 610, a filter 615, a mean calculator 620, a peak detector 625, and a fine path searcher 630.

An antenna receives a radio signal. The coarse path searcher 600 receives samples 603 of the received radio signal from a sampling device. The received samples 603 belong to an uncertainty region in a frame. The received radio signal is a mixture of channel noise, Wideband Code Division Multiple Access (WCDMA) transmitted by a Wideband Code Division Multiple Access (WCDMA) device, multipath components of the WCDMA signal, and noise. The WCDMA signal contains data signals and pilot signals. The pilot signal contains pilot channels of one of an uplink signal and a down link signal. The sampling device samples the radio signal at a sampling rate equal to product of an oversampling index and chip rate of the WCDMA signal. The sampling device generates a plurality of samples 603 of the received radio signal. Samples 603 of the received radio signal belong to a plurality of phases. The number of phases in the plurality of phases is equal to the oversampling index. The correlator 605 receives the samples 603 of the received radio signal.

The correlator 605 is at least one of a digital signal processor, Field Programmable Gate Array, and a microprocessor, and an application specific Integrated circuit. The correlator 605 performs a first set of correlation operations between a time shifted first set of samples and a local pattern to obtain correlation values within the uncertainty region. The first set of samples belongs to the received set of samples. Further, the first set of samples is made of samples having a first phase among the plurality of phases. The local pattern is product of a training sequence and a scrambling code of the user device. The training sequence contains pilot bits. The pilot bits are control bits known to be present in the pilot signal. As a result, correlation values peak when a sample of the received radio signal with pilot bits is correlated with the local pattern. Hence peaks in the correlation values signify the arrival of the pilot signal into the receiver antenna. The correlator 605 transmits output of the first set of correlation operations to the processor 610.

The processor 610 computes absolute values of results of the first set of correlation operations. Results of the first set of correlation operations are hereafter referred to as first set of correlation values. The filter 615 filters the absolute values of the first set of correlation values. The filter 615 is at least one of an analog filter and digital filter. The filter 615 transmits the first set of correlation values to the mean calculator 620.

The mean calculator 615 calculates noise mean of the received radio signal from the first set of correlation values. The noise mean of the received radio signal is average of the first set of correlation values. The coarse path searcher 600 transmits the noise mean to a fine path searcher 630. Further, the coarse path searcher 600 sets a threshold correlation value in order to identify correlation peak values. The threshold correlation value is product of a scaling factor K1 and the noise mean.

Further, the peak detector 625 identifies correlation values greater than the threshold correlation value as correlation peak values. The peak detector 625 determines N maximum correlation peak values. The peak detector 625 uses the correlation peak values to identify locations of one or more regions of interest in the frame of the WCDMA signal. Moreover, the coarse path searcher 600 informs the fine path searcher 630 of locations of the correlation peak values and the one or more regions of interest. Furthermore, the coarse path searcher 600 identifies the one or more regions of interest from the locations of the correlation peak values.

Techniques mentioned in the present disclosure invention are further applicable to communication systems where channel sounding is performed over a large time uncertainty region. The techniques in present disclosure are applicable to communication systems which fail to compensate for propagation delay.

Advantageously, the embodiments specified in the present disclosure provide a method of performing channel estimation in WCDMA system. The proposed invention reduces number of correlation operations required for channel estimation. Further, the proposed method increases speed of operation of channel estimators. Moreover, the proposed invention decreases cost of WCDMA base stations. Furthermore, the proposed invention is implementable in a femtocell base station. The proposed invention reduces power consumed by the WCDMA base station.

In the preceding specification, the present disclosure and its advantages have been described with reference to the specific embodiments. However, it will be apparent to a person with ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of present disclosure.

What is claimed is:

1. A system for performing channel estimation, the system comprising:
a sampling device for sampling a chip based radio signal to generate a plurality of samples;
a coarse path searcher for performing correlation operations of a local pattern with a time shifted first set of samples to obtain correlation values in an uncertainty region;
an Region of Interest (ROI) module to determine one or more regions of interest in the uncertainty region; and
a fine path searcher for performing correlation operations of the local pattern with a time shifted second set of samples to obtain correlation values in the one or more regions of interest.

2. The system as claimed in claim 1, wherein each chip in the chip based radio signal is sampled at plurality of phases.

3. The system as claimed in claim 1, further comprising a firmware override module for estimating channel state information.

4. The system as claimed in claim 1, wherein the coarse path searcher groups samples sharing a common phase to generate the first set of samples.

5. The system as claimed in claim 1, wherein the second set of samples comprises samples having a plurality of phases.

6. The system as claimed in claim 1, wherein the ROI module is operable to:
identify correlation peak values, wherein the correlation peak values are present in output of the correlation operations between the first set of samples and the local pattern;
select a correlation peak value above a threshold correlation value; and
identify portions of the uncertainty region as the regions of interest.

7. The system as claimed in claim 1, wherein the one of more regions of interest are regions with signal energy greater than threshold signal energy.

8. The system as claimed in claim 1, wherein the one or more regions of interest are regions where channel impulse response is expected to occur.

9. The system as claimed in claim 1, wherein the coarse path searcher comprises:
a correlator for performing correlation operations of the local pattern with the first set of samples;
a processor for computing absolute values of results of the correlation operations;
a mean calculator to calculate mean of the results of the correlation operations; and
a peak detector to identify correlation value peaks in the results of the correlation operations.

10. The system as claimed in claim 9, wherein the peak detector is further operable to:
estimate a threshold correlation value equal to product of a scaling factor and the mean; and
identify correlation values greater than the threshold correlation value as correlation peak values.

11. A method of performing channel estimation, the method comprising:
sampling a chip based radio signal to generate a plurality of samples;
performing correlation operations of a local pattern with a time shifted first set of samples to obtain correlation values in an uncertainty region;
determining one or more regions of interest;
performing correlation operations of the local pattern with a time shifted second set of samples to obtain correlation values in the one or more regions of interest; and
estimating channel state information based on the correlation operations of the local pattern with the second set of samples.

12. The method as claimed in claim 11, wherein each chip in the chip based radio signal is sampled at plurality of phases.

13. The method as claimed in claim 11, wherein a coarse path searcher groups samples sharing a common phase to generate the first set of samples.

14. The method as claimed in claim 11, wherein the second set of samples comprises samples having a plurality of phases.

15. The method as claimed in claim 11, wherein determining the one or more regions of interest comprises:
identifying correlation peak values;
selecting correlation peak values greater than a first threshold correlation value; and
identifying portions of the uncertainty region around the selected correlation peak values as one or more regions of interest.

16. The method as claimed in claim 15, wherein identifying correlation peak values comprises:
performing correlation operations of the local pattern with the first set of samples;
computing absolute values of results of the correlation operations;
calculating mean of the results of the correlation operations;
estimating a second threshold correlation value equal to product of a scaling factor and the mean; and
identifying correlation values greater than the second threshold correlation value as correlation peak values.

17. The method as claimed in claim 11, wherein the one of more regions of interest are regions with signal energy greater than a threshold signal energy.

18. The method as claimed in claim 11, wherein the one or more regions of interest are regions where channel impulse response is expected to occur.
